(19) United States
(12) Patent Application Publication
(10) Pub. No.: US 2026/0339002 A1
(43) Pub. Date: Oct. 29, 2026

(54) IMAGING LENS, CAMERA MODULE AND ELECTRONIC DEVICE

(71) Applicant: LARGAN PRECISION CO., LTD., Taichung City (TW)

(72) Inventors: Chien-Hsun WU, Taichung City (TW); Cheng-Feng LIN, Taichung City (TW); Yu Chen LAI, Taichung City (TW)

(73) Assignee: LARGAN PRECISION CO., LTD., Taichung City (TW)

(21) Appl. No.: 19/275,413

(22) Filed: Jul. 21, 2025

(30) Foreign Application Priority Data
Apr. 25, 2025 (TW) 114115787

(51) Int. Cl. G02B 5/00; G02B 3/08

(52) U.S. Cl. CPC G02B 5/005; G02B 3/08

(57) ABSTRACT

An imaging lens includes a plurality of lens elements sequentially arranged from an object side to an image side along an optical path, and a central axis of the imaging lens passes through a center of each of plurality of lens elements. The plurality of lens elements include a center-shielding lens element, and the center-shielding lens element includes a first optical surface and a second optical surface. The central axis passes through the first optical surface, and the second optical surface is disposed opposite to the first optical surface. The second optical surface includes a center-shielding region and an optical transmission region. The central axis passes through the center-shielding region, and the center-shielding region includes a light-shielding layer. The optical transmission region is disposed adjacent to and surrounds the center-shielding region. An inner side and an outer side of the center-shielding region both have low reflectivity characteristics.

### RELATED APPLICATIONS

This application claims priority to Taiwan Application 114115787, filed on Apr. 25, 2025, which is incorporated by reference herein in its entirety.

### BACKGROUND

### Technical Field

The present disclosure relates to an imaging lens, a camera module and an electronic device, more particularly to an imaging lens and a camera module applicable to an electronic device.

### Description of Related Art

With the development of semiconductor manufacturing technology, the performance of image sensors has been improved, and the pixel size thereof has been scaled down. Therefore, featuring high image quality becomes one of the indispensable features of an imaging lens nowadays. Furthermore, due to the rapid changes in technology, smartphone devices equipped with imaging lenses are trending towards multi-functionality for various applications, and therefore the functionality requirements for the imaging lenses have been increasing.

With the increasing demands for photography, imaging lenses are required to adapt to increasingly harsh environments. In conventional technologies, when light is reflected by an optical surface inside a lens element, the resulting glare phenomenon often leads to degradation of image quality. Typically, such glare can only be suppressed by limited means such as coatings. However, these means suffer from issues such as restricted design flexibility and unstable effectiveness, making it difficult to eliminate glare caused by internal reflections, thereby limiting the overall performance of the optical system. Accordingly, improving the shielding configuration of imaging lenses to address the problem of glare caused by internal reflections has become an important issue in the related technical fields.

### SUMMARY

According to one aspect of the present disclosure, an imaging lens includes a plurality of lens elements sequentially arranged from an object side to an image side along an optical path, and a central axis of the imaging lens passes through a center of each of the plurality of lens elements. The plurality of lens elements includes a center-shielding lens element, and the center-shielding lens element includes a first optical surface and a second optical surface. The central axis passes through the first optical surface, and the second optical surface is disposed opposite to the first optical surface. The second optical surface includes a center-shielding region and an optical transmission region. The central axis passes through the center-shielding region, and the center-shielding region includes a light-shielding layer. The optical transmission region is disposed adjacent to and surrounds the center-shielding region. In addition, an inner side and an outer side of the center-shielding region both have low reflectivity characteristics.

According to another aspect of the present disclosure, an imaging lens includes a plurality of lens elements sequentially arranged from an object side to an image side along an optical path, and a central axis of the imaging lens passes through a center of each of the plurality of lens elements. The plurality of lens elements includes a center-shielding lens element, and the center-shielding lens element includes a first optical surface and a second optical surface. The central axis passes through the first optical surface, and the second optical surface is disposed opposite to the first optical surface. The second optical surface includes a center-shielding region and an optical transmission region. The central axis passes through the center-shielding region, and the center-shielding region includes a light-shielding layer. The optical transmission region is disposed adjacent to and surrounds the center-shielding region. In addition, a matte structure is provided on the center-shielding region, and at least a part of the light-shielding layer is disposed on the matte structure.

According to another aspect of the present disclosure, a camera module includes the aforementioned imaging lens and an image sensor disposed on an image surface of the imaging lens.

According to another aspect of the present disclosure, an electronic device includes the aforementioned camera module.

### BRIEF DESCRIPTION OF THE DRAWINGS

The disclosure can be better understood by reading the following detailed description of the embodiments, with reference made to the accompanying drawings as follows:

FIG. 1 is a cross-sectional view of a camera module according to the 1st embodiment of the present disclosure;

FIG. 2 is a cross-sectional view of a center-shielding lens element in the imaging lens of camera module in FIG. 1;

FIG. 3 is an enlarged view of region EL3 in FIG. 2;

FIG. 4 is a projection view of the center-shielding lens element of FIG. 2 in a direction perpendicular to a central axis;

FIG. 5 is an enlarged view of region EL5 in FIG. 4;

FIG. 6 is a cross-sectional view of a camera module according to the 2nd embodiment of the present disclosure;

FIG. 7 is a cross-sectional view of a center-shielding lens element in the imaging lens of camera module in FIG. 6;

FIG. 8 is an enlarged view of region EL8 in FIG. 7;

FIG. 9 is a projection view of the center-shielding lens element of FIG. 7 in a direction perpendicular to a central axis;

FIG. 10 is an enlarged view of region EL10 in FIG. 9;

FIG. 11 is a cross-sectional view of a camera module according to the 3rd embodiment of the present disclosure;

FIG. 12 is a cross-sectional view of a center-shielding lens element in the imaging lens of camera module in FIG. 11;

FIG. 13 is an enlarged view of region EL13 in FIG. 12;

FIG. 14 is a projection view of the center-shielding lens element of FIG. 12 in a direction perpendicular to a central axis;

FIG. 15 is an enlarged perspective view of region EL15 in FIG. 14;

FIG. 16 is an enlarged perspective view of a matte structure according to another configuration of the present disclosure;

FIG. 17 is an enlarged perspective view of a matte structure according to another configuration of the present disclosure;

FIG. 18 is a perspective view of an electronic device according to the 4th embodiment of the present disclosure;

FIG. 19 is another perspective view of the electronic device in FIG. 18;

FIG. 20 is an illustration of an image captured by an ultra-wide-angle camera module;

FIG. 21 is an illustration of an image captured by a high pixel camera module;

FIG. 22 is an illustration of an image captured by a telephoto camera module;

FIG. 23 is a perspective view of an electronic device according to the 5th embodiment of the present disclosure;

FIG. 24 is a perspective view of an electronic device according to the 6th embodiment of the present disclosure;

FIG. 25 is a side view of the electronic device in FIG. 24; and

FIG. 26 is a top view of the electronic device in FIG. 24.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The present disclosure provides an imaging lens. The imaging lens includes a plurality of lens elements sequentially arranged from an object side to an image side along an optical path, and a central axis of the imaging lens passes through a center of each of the plurality of lens elements. The plurality of lens elements includes a center-shielding lens element, and the center-shielding lens element includes a first optical surface and a second optical surface. In addition, the central axis passes through the first optical surface, and the second optical surface is disposed opposite to the first optical surface. Moreover, the center-shielding lens element can be a glass lens element or a plastic lens element, but the present disclosure is not limited to specific material types.

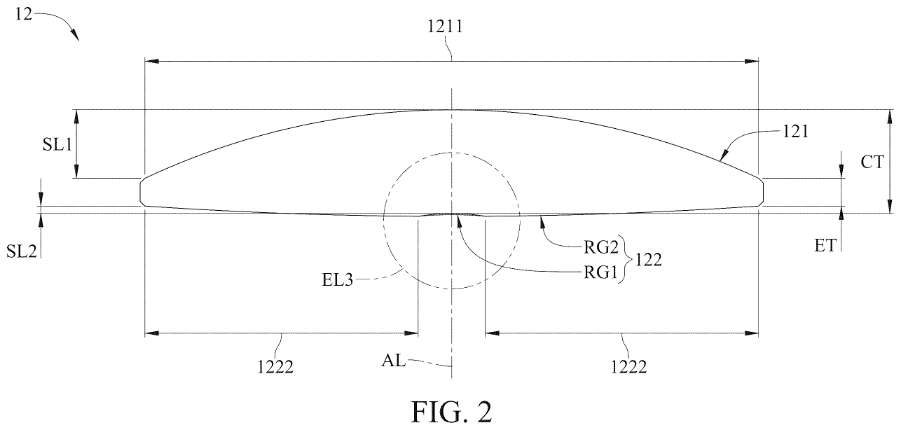

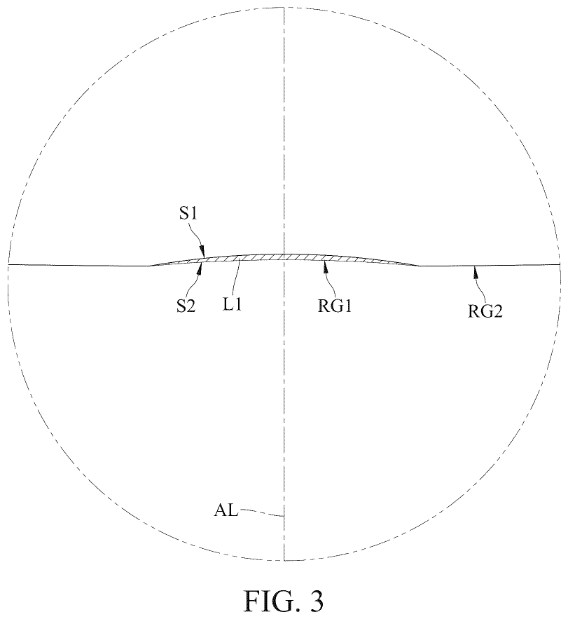

The second optical surface includes a center-shielding region and an optical transmission region. The central axis passes through the center-shielding region, and the center-shielding region includes a light-shielding layer. Moreover, light-shielding layer can be made of a black material to suppress unwanted light from entering subsequent optical elements, but the present disclosure is not limited thereto. For example, please refer to FIG. 2 and FIG. 3, which show schematic views of the center-shielding region and the light-shielding layer thereof according to the 1st embodiment of the present disclosure. It should be noted that, in the drawings of the present disclosure, the light-shielding layer illustrated is merely a schematic representation of its placement, and the actual thickness and material characteristics are not limited to the configurations depicted in the drawings.

The optical transmission region is disposed adjacent to and surrounds the center-shielding region, allowing imaging light to pass through the optical transmission region and subsequently through the overall lens system. The imaging light path passes through the first optical surface and the second optical surface, and eventually forms an image on an image surface of the imaging lens.

According to the imaging lens of the present disclosure, by providing a light-shielding layer at the center of the lens element, glare caused by reflections at the central surface of the lens element can be eliminated while maintaining optical imaging quality, thereby improving the overall optical performance.

In one aspect, an inner side and an outer side of the center-shielding region both have low reflectivity characteristics. The inner side of the center-shielding region refers to the center-shielding region as viewed from the first optical surface, while the outer side of the center-shielding region refers to the center-shielding region as viewed from the second optical surface, and the outer side can further be a surface of the light-shielding layer. The low reflectivity characteristic can be defined as a reflectance of less than 30%. In some aspects, the reflectance can further be less than 15%. In other aspects, the reflectance can further be less than 5%. The inner side of the center-shielding region having a low reflectivity characteristic refers to a reflectance of less than 30% as measured from the first optical surface. Therefore, glare caused by reflections at internal surfaces of the lens element can be eliminated, thereby maintaining imaging quality and overall optical performance. The outer side of the center-shielding region having a low reflectivity characteristic refers to a reflectance of less than 30% as measured from the second optical surface. Therefore, glare caused by reflections between the center-shielding lens element and other optical surfaces can be eliminated, thereby enhancing optical quality.

In one configuration, a matte structure can be provided on the center-shielding region, and at least a part of the light-shielding layer can be disposed on the matte structure. Therefore, it is favorable for reducing reflection and enhancing the attachment of the light-shielding layer.

When the number of the plurality of lens elements (i.e., the total number of lens elements in the imaging lens) is N, and the number of lens elements disposed on an image side of the center-shielding lens element among the plurality of lens elements is M, the following condition can be satisfied: N×0.5≤M. Therefore, it is favorable for reducing the effect of the center-shielding region on the imaging light, thereby maintaining the optical quality.

The center-shielding lens element can be a lens element closest to the object side among the plurality of lens elements. Therefore, it is favorable for reducing the probability of non-imaging light entering other lens elements, thereby enhancing the overall optical quality.

According to the present disclosure, the imaging lens can further include a reflective element, and the center-shielding lens element can be disposed on an object side of the reflective element. Therefore, it is favorable for effectively optimizing the distribution of light entering the reflective element, thereby reducing the risk of glare generated by the reflective element.

The reflective element can include a plurality of reflective surfaces. Therefore, it is favorable for achieving an optical path folding effect through multiple reflections, thereby effectively minimizing the overall size of the imaging lens and increasing the flexibility of system design. Moreover, the reflective surfaces may be three or more in number.

The first optical surface can be disposed on an object side of the center-shielding lens element, and the second optical surface can be disposed on the image side of the center-shielding lens element. Therefore, it is favorable for the incident light path to first be optimized via the first optical surface, thereby achieving optimal imaging performance and light-shielding effects.

The first optical surface can include an object-side effective optical area, and the optical transmission region of the second optical surface can include an image-side effective optical area. Additionally, the image-side effective optical area can be disposed adjacent to the center-shielding region, and the optical path sequentially passes through the object-side effective optical area and the image-side effective optical area. Moreover, in a direction parallel to the central axis, when a maximum distance from a position of the first optical surface passed through by the central axis to an outer edge of the object-side effective optical area farthest from the central axis is SL1, and a maximum distance from a position of the second optical surface passed through by the central axis to an outer edge of the image-side effective optical area farthest from the central axis is SL2, the following condition can be satisfied: 0.04≤SL2/SL1≤0.35. Therefore, it is favorable for improving the quality of light convergence, thereby reducing the influence of the shielding region on imaging. Moreover, the following condition can also be satisfied: 0.05≤SL2/SL1≤0.3. Moreover, the following condition can also be satisfied: 0.06≤SL2/SL1≤0.25. Please refer to FIG. 2, which shows a schematic view of SL1 and SL2 according to the 1st embodiment of the present disclosure.

The light-shielding layer can include a plurality of protruding edges disposed adjacent to the optical transmission region. The protruding edges can be sequentially arranged around the central axis, and each of the protruding edges can gradually taper away from the central axis. Moreover, the shape of the protruding edges can include arcuate, conical, acute-angled, or obtuse-angled forms, but the present disclosure is not limited thereto. Moreover, the protruding edges can be interconnected via arcuate transitions.

The matte structure can be provided on a surface of the center-shielding region, and the matte structure can be rougher than a surface of the optical transmission region. When a surface roughness difference between the matte structure and the surface of the optical transmission region is ΔR, the following condition can be satisfied: Ra 0.1 μm≤ΔR≤Ra 7.0 μm, where Ra represents an arithmetic average roughness. Therefore, it is favorable for further reducing reflection and enhancing the attachment of the light-shielding layer. Moreover, the following condition can also be satisfied: Ra 0.12 μm≤ΔR≤Ra 6.0 μm. Moreover, the following condition can also be satisfied: Ra 0.15 μm≤ΔR≤Ra 5.0 μm.

In one configuration, the matte structure can include a plurality of protruding structures sequentially arranged based on the central axis. Therefore, by providing protruding structures, the low-reflectivity effect can be further enhanced and the attachment of the light-shielding layer can be improved. Moreover, the protruding structures can be sequentially arranged in a circumferential direction relative to the central axis or in a direction perpendicular to the central axis, thereby forming an array pattern arranged based on the central axis.

The center-shielding region can include a wall surface and a bottom surface. The wall surface extends from a side of the optical transmission region closest to the central axis towards the first optical surface, and the bottom surface is connected to a side of the wall surface farthest from the optical transmission region. In addition, the light-shielding layer can be disposed on the wall surface and the bottom surface. Therefore, it is favorable for the center-shielding region to be formed into a bowl-shaped structure to increase the thickness of the light-shielding layer, thereby improving the light-shielding performance.

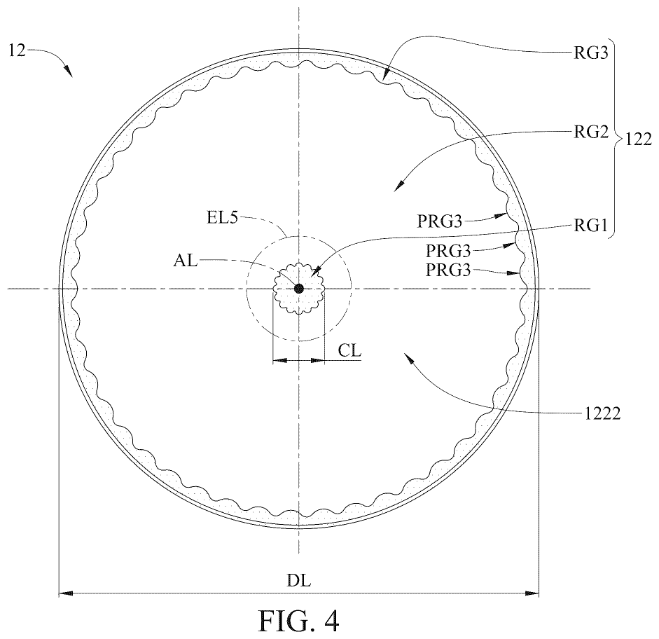

On a projection plane perpendicular to the central axis, when a maximum shielding width of the center-shielding region is defined as CL, and a maximum outer diameter of the center-shielding lens element is defined as DL, the following condition can be satisfied: 0.03≤CL/DL≤0.33. Therefore, it is favorable for properly maintaining the balance between light transmission and light shielding, thereby ensuring imaging quality while eliminating glare. Moreover, the following condition can also be satisfied: 0.04≤CL/DL≤0.3. Moreover, the following condition can also be satisfied: 0.05≤CL/DL≤0.25. Please refer to FIG. 4, which shows a schematic view of CL and DL according to the 1st embodiment of the present disclosure.

The center-shielding lens element can be a non-circular lens element and can include at least one trimmed edge, and the trimmed edge is recessed towards the central axis. Therefore, the use of a non-circular lens element can contribute to the reduction of the size and weight of the imaging lens. Moreover, the center-shielding lens element can include a single trimmed edge or two opposing trimmed edges, and the present disclosure is not limited to the number of trimmed edges.

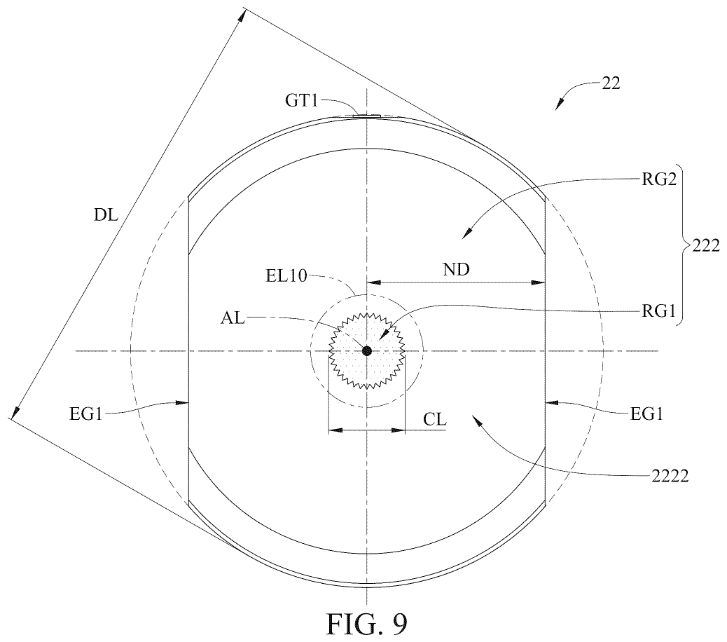

On a projection plane perpendicular to the central axis, when a minimum distance between the trimmed edge and the central axis is defined as ND, and the maximum outer diameter of the center-shielding lens element is defined as DL, the following condition can be satisfied: 0.49≤ND×2/DL≤0.9. Therefore, it is favorable for preventing excessive shielding that may result in degradation of imaging quality. Moreover, the following condition can also be satisfied: 0.55≤ND×2/DL≤0.85. Moreover, the following condition can also be satisfied: 0.6≤ND×2/DL≤0.8. It should be noted that the center of the maximum outer diameter must be aligned with the central axis. Please refer to FIG. 9, which shows a schematic view of ND and DL according to the 2nd embodiment of the present disclosure.

On a projection plane perpendicular to the central axis, when the maximum shielding width of the center-shielding region is defined as CL, and the minimum distance between the trimmed edge and the central axis is defined as ND, the following condition can be satisfied: 0.04≤CL/(ND×2)≤0.45. Therefore, it is favorable for preventing excessive shielding that may result in degradation of imaging quality. Moreover, the following condition can also be satisfied: 0.05≤CL/(ND×2)≤0.4. Moreover, the following condition can also be satisfied: 0.06≤CL/(ND×2)≤0.3. Please refer to FIG. 9, which shows a schematic view of CL and ND according to the 2nd embodiment of the present disclosure.

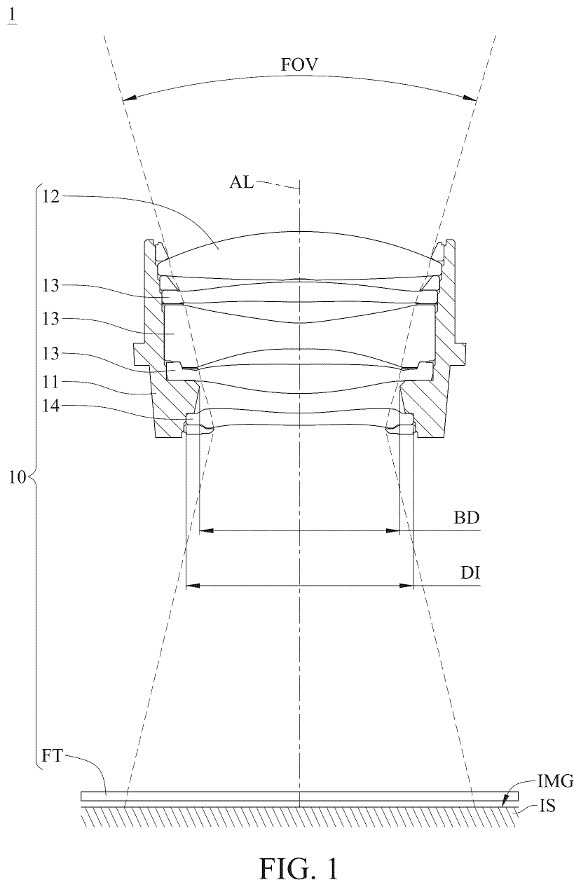

When a field of view of the imaging lens is FOV, the following condition can be satisfied: 6 degrees≤FOV≤65 degrees. Therefore, it is favorable for reducing the impact of the light-shielding layer on the imaging light quality, thereby improving the overall optical quality. Moreover, the following condition can also be satisfied: 8 degrees≤FOV≤55 degrees. Moreover, the following condition can also be satisfied: 10 degrees≤FOV≤45 degrees. Please refer to FIG. 1, which shows a schematic view of FOV according to the 1st embodiment of the present disclosure.

The optical transmission region of the second optical surface of the center-shielding lens element can include the image-side effective optical area disposed adjacent to the center-shielding region, and the optical path passes through the image-side effective optical area. Moreover, when a minimum distance between the outer edge of the image-side effective optical area farthest from the central axis and the first optical surface is ET, and a central thickness of the center-shielding lens element defined by the central axis passing through a center of the center-shielding lens element is CT, the following condition can be satisfied: 0.13≤ET/CT≤0.95. Therefore, it is favorable for controlling the reflection direction of non-imaging light, thereby effectively suppressing glare. Moreover, the following condition can also be satisfied: 0.15≤ET/CT≤0.8. Moreover, the following condition can also be satisfied: 0.2≤ET/CT≤0.7. Moreover, the center-shielding lens element can be a positive lens element. Please refer to FIG. 2, which shows a schematic view of ET and CT according to the 1st embodiment of the present disclosure.

According to the present disclosure, the imaging lens can further include a barrel, and the center-shielding lens element is disposed on the barrel. The barrel includes a minimum through hole, and the central axis passes through the minimum through hole. Moreover, on a projection plane perpendicular to the central axis, when the maximum shielding width of the center-shielding region is defined as CL, and a through hole diameter of the minimum through hole is defined as BD, the following condition can be satisfied: 0.03≤CL/BD≤0.52. Therefore, it is favorable for the size of the light-shielding layer to be matched with the minimum through hole to enhance the shielding quality and ensure that the imaging lens receives an optimal amount of incident light. Moreover, the following condition can also be satisfied: 0.04≤CL/BD≤0.45. Moreover, the following condition can also be satisfied: 0.05≤CL/BD≤0.35. Please refer to FIG. 1 and FIG. 4, which respectively show schematic views of BD and CL according to the 1st embodiment of the present disclosure.

The plurality of lens elements includes a rearmost lens element, and the rearmost lens element is a lens element closest to the image side among the plurality of lens elements. Moreover, on a projection plane perpendicular to the central axis, when a rearmost lens outer diameter of the rearmost lens element is defined as DI, and the maximum outer diameter of the center-shielding lens element is defined as DL, the following condition can be satisfied: 0.6≤DI/DL≤1.4. Therefore, it is favorable for the size of the rearmost lens element to be matched with the size of the center-shielding lens element to enhance imaging quality. Moreover, the following condition can also be satisfied: 0.65≤DI/DL≤1.2. Moreover, the following condition can also be satisfied: 0.7≤DI/DL≤1.1. Please refer to FIG. 1 and FIG. 4, which respectively show schematic views of DI and DL according to the 1st embodiment of the present disclosure.

The second optical surface of the center-shielding lens element can further include a peripheral shielding region disposed on a side of the optical transmission region farthest from the center-shielding region. Therefore, by further providing the light-shielding layer on the peripheral shielding region, the imaging light passing through the center-shielding lens element can be optimized, and glare caused by non-imaging light passing through the peripheral shielding region can be prevented. Moreover, the peripheral shielding region can also include a plurality of protruding edges sequentially arranged around the central axis, and each of the protruding edges can gradually taper toward the center-shielding region.

The plurality of lens elements can include a first lens group and a second lens group, the second lens group is disposed on an image side of the first lens group, and each of the first lens group and the second lens group includes at least one lens element. In addition, the center-shielding lens element can be located in the first lens group, and an axial distance between the first lens group and the second lens group is variable. Therefore, the multi-lens-group configuration can reduce the movement distance of the light-shielding layer along the central axis, thereby optimizing optical quality. In one configuration, the second lens group is movable along the direction of the central axis. Therefore, by changing the distance between the second lens group and the first lens group, optical functions such as focusing and zooming can be achieved.

According to the present disclosure, a camera module is provided. The camera module includes an image sensor and the aforementioned imaging lens, and the image sensor is disposed on the image surface of the imaging lens.

According to the present disclosure, an electronic device is provided. The electronic device includes the aforementioned camera module.

According to the present disclosure, the aforementioned features and conditions can be utilized in numerous combinations so as to achieve corresponding effects.

According to the above description of the present disclosure, the following specific embodiments are provided for further explanation.

### 1st Embodiment

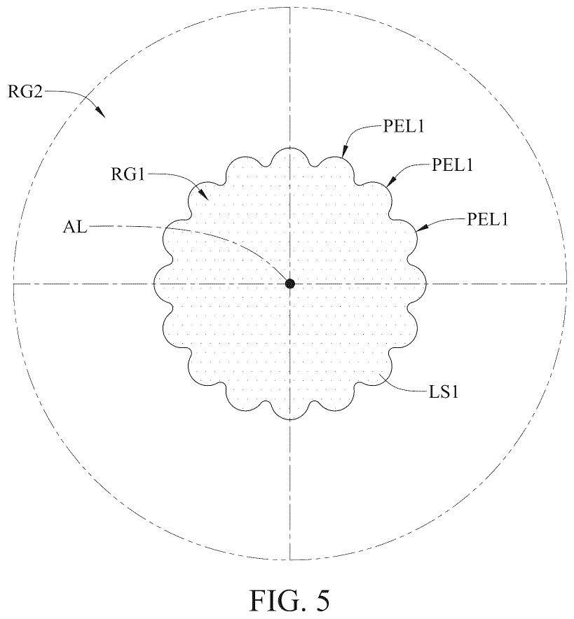

Please refer to FIG. 1 to FIG. 5. FIG. 1 is a cross-sectional view of a camera module according to the 1st embodiment of the present disclosure, FIG. 2 is a cross-sectional view of a center-shielding lens element in the imaging lens of camera module in FIG. 1, FIG. 3 is an enlarged view of region EL3 in FIG. 2, FIG. 4 is a projection view of the center-shielding lens element of FIG. 2 in a direction perpendicular to a central axis, and FIG. 5 is an enlarged view of region EL5 in FIG. 4.

A camera module 1 is provided in this embodiment. The camera module 1 includes an imaging lens 10 and an image sensor IS. The imaging lens 10 includes a barrel 11, a plurality of lens elements 12, 13 and 14, a filter FT and an image surface IMG. The barrel 11 includes a minimum through hole (its reference numeral is omitted, but referable to the location indicated by the parameter BD shown in FIG. 1), and a central axis AL of the imaging lens 10 passes through the minimum through hole. The lens elements 12, 13 and 14 are disposed on the barrel 11 and sequentially arranged from an object side to an image side along an optical path, and the central axis AL passes through passes through a center of each of the lens elements 12, 13 and 14. The filter FT is disposed between the lens elements 12, 13 and 14 and the image surface IMG, and the image sensor IS is disposed on the image surface IMG.

The lens elements 12, 13 and 14 includes a center-shielding lens element 12 and a rearmost lens element 14, the center-shielding lens element 12 is a lens element closest to the object side among the lens elements 12, 13 and 14, and rearmost lens element 14 is a lens element closest to the image side among the lens elements 12, 13 and 14. Moreover, the center-shielding lens element 12 is a positive lens element.

The center-shielding lens element 12 includes a first optical surface 121 and a second optical surface 122. The central axis AL passes through the first optical surface 121, and the second optical surface 122 is disposed opposite to the first optical surface 121. Moreover, the first optical surface 121 is disposed on an object side of the center-shielding lens element 12, and the second optical surface 122 is disposed on an image side of the center-shielding lens element 12. In other words, the first optical surface 121 can be an object-side surface of the center-shielding lens element 12, and the second optical surface 122 can be an image-side surface of the center-shielding lens element 12. Imaging optical path sequentially passes through the first optical surface 121 and the second optical surface 122, then passes through the lens elements 13 and 14 and the filter FT disposed on the image side of the center-shielding lens element 12, and eventually forms an image on the image surface IMG.

The second optical surface 122 includes a center-shielding region RG1, an optical transmission region RG2 and a peripheral shielding region RG3. The central axis AL passes through the center-shielding region RG1, and the center-shielding region RG1 includes a light-shielding layer L1. The optical transmission region RG2 is disposed adjacent to and surrounds the center-shielding region RG1. The peripheral shielding region RG3 is disposed on a side of the optical transmission region RG2 farthest from the center-shielding region RG1.

As shown in FIG. 4 and FIG. 5, the light-shielding layer L1 includes a plurality of protruding edges PEL1 disposed adjacent to the optical transmission region RG2, the protruding edges PEL1 are sequentially arranged around the central axis AL, and each of the protruding edges PEL1 gradually tapers away from the central axis AL. In this embodiment, the shape of the protruding edges PEL1 is arcuate, and the protruding edges PEL1 are interconnected via arcuate transitions.

As shown in FIG. 4, the peripheral shielding region RG3 includes a plurality of protruding edges PRG3 sequentially arranged around the central axis AL, and each of the protruding edges PRG3 gradually tapers toward the center-shielding region RG1.

An inner side S1 and an outer side S2 of the center-shielding region RG1 both have low reflectivity characteristics. Additionally, the outer side S2 of the center-shielding region RG1 is a surface of the light-shielding layer L1. In this embodiment, a reflectance of the inner side S1 of the center-shielding region RG1 is less than 30%, and a reflectance of the outer side S2 of the center-shielding region RG1 is also less than 30%.

As shown in FIG. 3 and FIG. 5, a matte structure LS1 is provided on the center-shielding region RG1, the matte structure LS1 is recessed towards the first optical surface 121, and at least a part of the light-shielding layer L1 is disposed on the matte structure LS1.

As shown in FIG. 2, the first optical surface 121 includes an object-side effective optical area 1211, and the optical transmission region RG2 of the second optical surface 122 includes an image-side effective optical area 1222. Furthermore, the image-side effective optical area 1222 is disposed adjacent to the center-shielding region RG1, and the optical path sequentially passes through the object-side effective optical area 1211 and the image-side effective optical area 1222. Moreover, in a direction parallel to the central axis AL, when a maximum distance from a position of the first optical surface 121 passed through by the central axis AL to an outer edge of the object-side effective optical area 1211 farthest from the central axis AL is SL1, and a maximum distance from a position of the second optical surface 122 passed through by the central axis AL to an outer edge of the image-side effective optical area 1222 farthest from the central axis AL is SL2, the following conditions are satisfied: SL1=0.71 mm; SL2=0.08 mm; and SL2/SL1=0.113.

As shown in FIG. 1, when the number of the lens elements 12, 13 and 14 is N, and the number of lens elements 13 and 14 disposed on the image side of the center-shielding lens element 12 is M, the following conditions are satisfied: N=5; M=4; and N×0.5≤M.

As shown in FIG. 5, the matte structure LS1 is provided on a surface of the center-shielding region RG1, and the matte structure LS1 is rougher than a surface of the optical transmission region RG2. In this embodiment, a roughness of the matte structure LS1 of the center-shielding region RG1 is between Ra 0.3 μm and 0.5 μm, and a roughness of the optical transmission region RG2 is less than Ra 0.1 μm, where Ra represents the arithmetic average roughness. Moreover, when a surface roughness difference between the matte structure LS1 and the surface of the optical transmission region RG2 is ΔR, the following conditions are satisfied: Ra 0.1 μm≤ΔR≤Ra 7.0 μm.

As shown in FIG. 4, on a projection plane perpendicular to the central axis AL, when a maximum shielding width of the center-shielding region RG1 is defined as CL, and a maximum outer diameter of the center-shielding lens element 12 is defined as DL, the following conditions are satisfied: CL=0.70 mm; DL=6.5 mm; and CL/DL=0.108.

As shown in FIG. 1, when a field of view of the imaging lens 10 is FOV, the following condition is satisfied: FOV=32.6 degrees. Moreover, the field of view of the imaging lens 10 corresponds to a maximum image height of the image sensor IS (its reference numeral is omitted, but corresponds to the intersection between the optical path and the image sensor IS as shown in FIG. 1).

As shown in FIG. 2, when a minimum distance between the outer edge of the image-side effective optical area 1222 farthest from the central axis AL and the first optical surface 121 is ET, and a central thickness of the center-shielding lens element 12 defined by the central axis AL passing through a center of the center-shielding lens element 12 is CT, the following conditions are satisfied: ET=0.29 mm; CT=1.08 mm; and ET/CT=0.269.

As shown in FIG. 1 and FIG. 4, on a projection plane perpendicular to the central axis AL, when the maximum shielding width of the center-shielding region RG1 is defined as CL, and a through hole diameter of the minimum through hole is defined as BD, the following conditions are satisfied: CL=0.70 mm; BD=4.58 mm; and CL/BD=0.152.

As shown in FIG. 1 and FIG. 4, on a projection plane perpendicular to the central axis AL, when a rearmost lens outer diameter of the rearmost lens element 14 is defined as DI, and the maximum outer diameter of the center-shielding lens element 12 is defined as DL, the following conditions are satisfied: DI=5.2 mm; DL=6.5 mm; and DI/DL=0.8.

### 2nd Embodiment

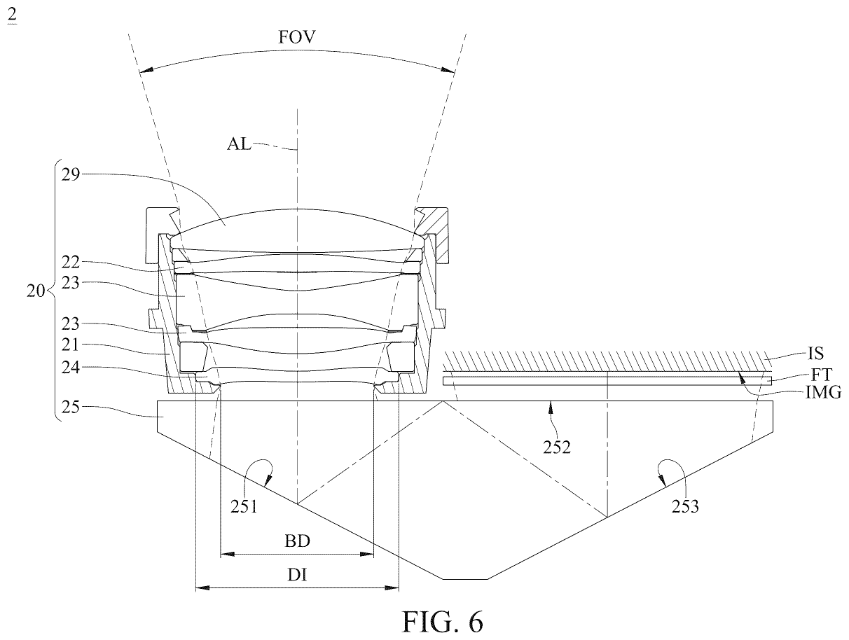

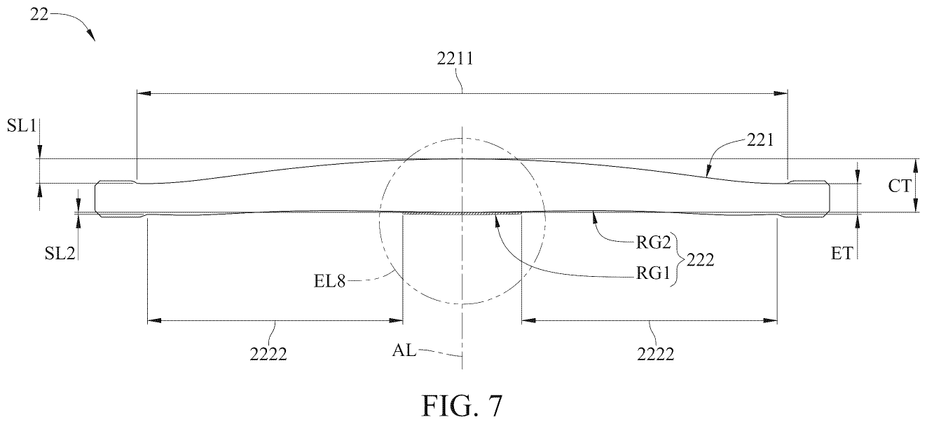

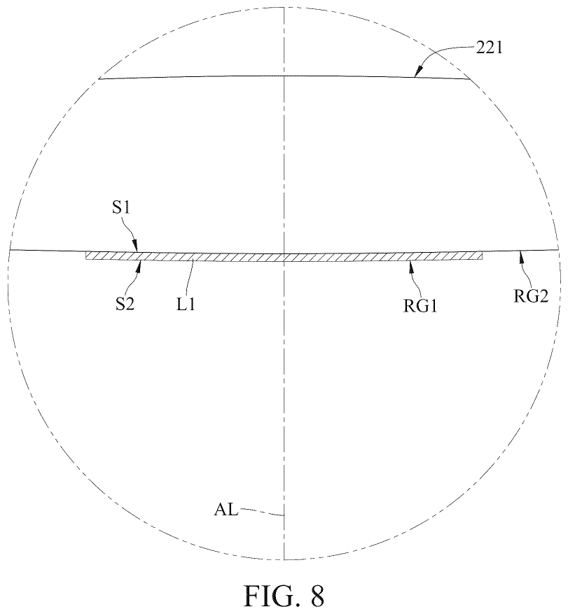

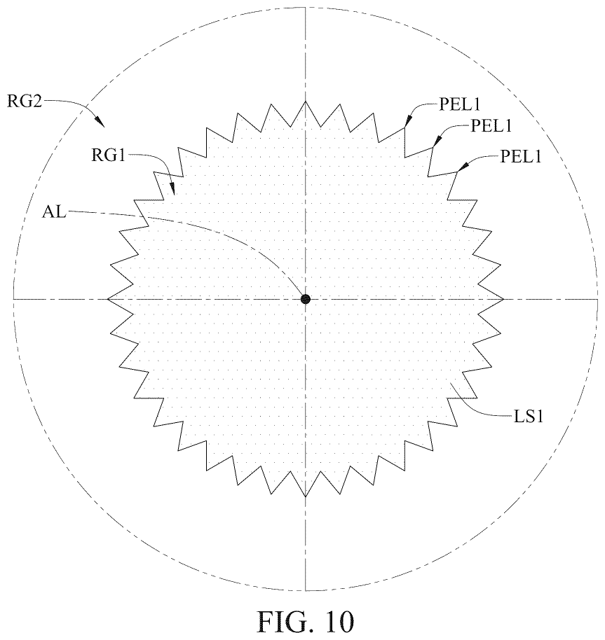

Please refer to FIG. 6 to FIG. 10. FIG. 6 is a cross-sectional view of a camera module according to the 2nd embodiment of the present disclosure, FIG. 7 is a cross-sectional view of a center-shielding lens element in the imaging lens of camera module in FIG. 6, FIG. 8 is an enlarged view of region EL8 in FIG. 7, FIG. 9 is a projection view of the center-shielding lens element of FIG. 7 in a direction perpendicular to a central axis, and FIG. 10 is an enlarged view of region EL10 in FIG. 9.

A camera module 2 is provided in this embodiment. The camera module 2 includes an imaging lens 20 and an image sensor IS. The imaging lens 20 includes a barrel 21, a plurality of lens elements 29, 22, 23 and 24, a reflective element 25, a filter FT and an image surface IMG. The barrel 21 includes a minimum through hole (its reference numeral is omitted, but referable to the location indicated by the parameter BD shown in FIG. 6), and a central axis AL of the imaging lens 20 passes through the minimum through hole. The lens elements 29, 22, 23 and 24 are disposed on the barrel 21 and sequentially arranged from an object side to an image side along an optical path, and the central axis AL passes through a center of each of the lens elements 29, 22, 23 and 24. The reflective element 25 is disposed between the lens elements 29, 22, 23 and 24 and the filter FT in the direction of the optical path, the filter FT is disposed between the reflective element 25 and the image surface IMG in the direction of the optical path, and the image sensor IS is disposed on the image surface IMG.

The lens elements 29, 22, 23 and 24 includes a center-shielding lens element 22 and a rearmost lens element 24. The center-shielding lens element 22 is a second lens element counting from the object side among the lens elements 29, 22, 23 and 24, and the rearmost lens element 24 is a lens element closest to the image side among the lens elements 29, 22, 23 and 24. Moreover, the center-shielding lens element 22 is a positive lens element, and the center-shielding lens element 22 is disposed on an object side of the reflective element 25. In this embodiment, the reflective element 25 includes three reflective surfaces 251, 252 and 253.

The center-shielding lens element 22 includes a first optical surface 221 and a second optical surface 222. The central axis AL passes through the first optical surface 221, and the second optical surface 222 is disposed opposite to the first optical surface 221. Moreover, the first optical surface 221 is disposed on an object side of the center-shielding lens element 22, and the second optical surface 222 is disposed on an image side of the center-shielding lens element 22. In other words, the first optical surface 221 can be an object-side surface of the center-shielding lens element 22, and the second optical surface 222 can be an image-side surface of the center-shielding lens element 22. Imaging optical path sequentially passes through the lens element 29, the first optical surface 221 and the second optical surface 222 of the center-shielding lens element 22, then passes through the lens elements 23 and 24, the reflective element 25 and the filter FT disposed on the image side of the center-shielding lens element 22, and eventually forms an image on the image surface IMG.

The second optical surface 222 includes a center-shielding region RG1 and an optical transmission region RG2. The central axis AL passes through the center-shielding region RG1, and the center-shielding region RG1 includes a light-shielding layer L1. The optical transmission region RG2 is disposed adjacent to and surrounds the center-shielding region RG1.

As shown in FIG. 9 and FIG. 10, the light-shielding layer L1 includes a plurality of protruding edges PEL1 disposed adjacent to the optical transmission region RG2, the protruding edges PEL1 are sequentially arranged around the central axis AL, and each of the protruding edges PEL1 gradually tapers away from the central axis AL. In this embodiment, the shape of the protruding edges PEL1 is acute-angled.

An inner side S1 and an outer side S2 of the center-shielding region RG1 both have low reflectivity characteristics. Additionally, the outer side S2 of the center-shielding region RG1 is a surface of the light-shielding layer L1. In this embodiment, a reflectance of the inner side S1 of the center-shielding region RG1 is less than 30%, and a reflectance of the outer side S2 of the center-shielding region RG1 is also less than 30%.

As shown in FIG. 8 and FIG. 10, a matte structure LS1 is provided on the center-shielding region RG1, and at least a part of the light-shielding layer L1 is disposed on the matte structure LS1.

As shown in FIG. 9, the center-shielding lens element 22 is a non-circular lens element and includes two trimmed edges EG1 disposed opposite to each other, and the trimmed edges EG1 are recessed towards the central axis AL. In addition, the center-shielding lens element 22 is a plastic lens element including a gate trace GT1 at its outer diameter, and the gate trace GT1 is located at a peripheral portion connecting the two trimmed edges EG1.

As shown in FIG. 7, the first optical surface 221 includes an object-side effective optical area 2211, and the optical transmission region RG2 of the second optical surface 222 includes an image-side effective optical area 2222. Furthermore, the image-side effective optical area 2222 is disposed adjacent to the center-shielding region RG1, and the optical path sequentially passes through the object-side effective optical area 2211 and the image-side effective optical area 2222. Moreover, in a direction parallel to the central axis AL, when a maximum distance from a position of the first optical surface 221 passed through by the central axis AL to an outer edge of the object-side effective optical area 2211 farthest from the central axis AL is SL1, and a maximum distance from a position of the second optical surface 222 passed through by the central axis AL to an outer edge of the image-side effective optical area 2222 farthest from the central axis AL is SL2, the following conditions are satisfied: SL1=0.21 mm; SL2=0.02 mm; and SL2/SL1=0.095.

As shown in FIG. 6, when the number of the lens elements 22, 23 and 24 is N, and the number of lens elements 23 and 24 disposed on the image side of the center-shielding lens element 22 is M, the following conditions are satisfied: N=5; M=3; and N×0.5≤M.

As shown in FIG. 10, the matte structure LS1 is provided on a surface of the center-shielding region RG1, and the matte structure LS1 is rougher than a surface of the optical transmission region RG2. In this embodiment, a roughness of the matte structure LS1 of the center-shielding region RG1 is between Ra 2.8 μm and 3.5 μm, and a roughness of the optical transmission region RG2 is less than Ra 0.1 μm, where Ra represents the arithmetic average roughness. Moreover, when a surface roughness difference between the matte structure LS1 and the surface of the optical transmission region RG2 is ΔR, the following conditions are satisfied: Ra 0.1 μm≤ΔR≤Ra 7.0 μm.

As shown in FIG. 9, on a projection plane perpendicular to the central axis AL, when a maximum shielding width of the center-shielding region RG1 is defined as CL, and a maximum outer diameter of the center-shielding lens element 22 is defined as DL, the following conditions are satisfied: CL=1.02 mm; DL=6.3 mm; and CL/DL=0.162.

As shown in FIG. 9, on a projection plane perpendicular to the central axis AL, when a minimum distance between the trimmed edge EG1 and the central axis AL is defined as ND, and the maximum outer diameter of the center-shielding lens element 22 is defined as DL, the following conditions are satisfied: ND=2.38 mm; DL=6.3 mm; and ND×2/DL=0.756. Moreover, the center of the maximum outer diameter DL is aligned with the central axis AL.

As shown in FIG. 9, on a projection plane perpendicular to the central axis AL, when the maximum shielding width of the center-shielding region RG1 is defined as CL, and the minimum distance between the trimmed edge EG1 and the central axis AL is defined as ND, the following conditions are satisfied: CL=1.02 mm; ND=2.38 mm; and CL/(ND×2)=0.214.

As shown in FIG. 6, when a field of view of the imaging lens 20 is FOV, the following condition is satisfied: FOV=32.6 degrees. Moreover, the field of view of the imaging lens 20 corresponds to a maximum image height of the image sensor IS (its reference numeral is omitted, but corresponds to the intersection between the optical path and the image sensor IS as shown in FIG. 6).

As shown in FIG. 7, when a minimum distance between the outer edge of the image-side effective optical area 2222 farthest from the central axis AL and the first optical surface 221 is ET, and a central thickness of the center-shielding lens element 22 defined by the central axis AL passing through a center of the center-shielding lens element 22 is CT, the following conditions are satisfied: ET=0.26 mm; CT=0.46 mm; and ET/CT=0.565.

As shown in FIG. 6 and FIG. 9, on a projection plane perpendicular to the central axis AL, when the maximum shielding width of the center-shielding region RG1 is defined as CL, and a through hole diameter of the minimum through hole is defined as BD, the following conditions are satisfied: CL=1.02 mm; BD=3.92 mm; and CL/BD=0.260.

As shown in FIG. 6 and FIG. 9, on a projection plane perpendicular to the central axis AL, when a rearmost lens outer diameter of the rearmost lens element 24 is defined as DI, and the maximum outer diameter of the center-shielding lens element 22 is defined as DL, the following conditions are satisfied: DI=5.2 mm; DL=6.3 mm; and DI/DL=0.825.

### 3rd Embodiment

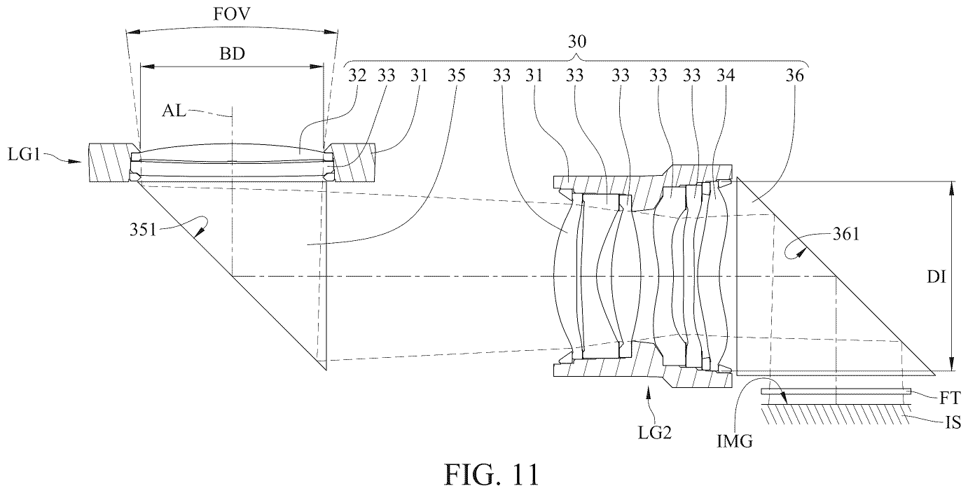

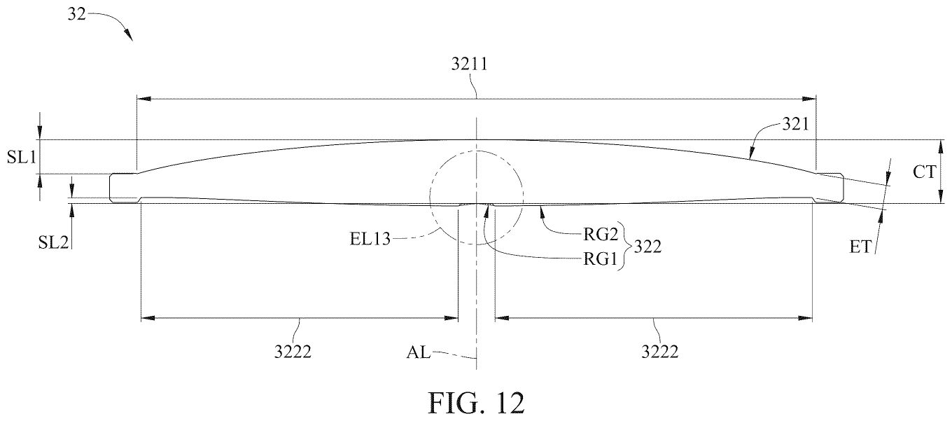

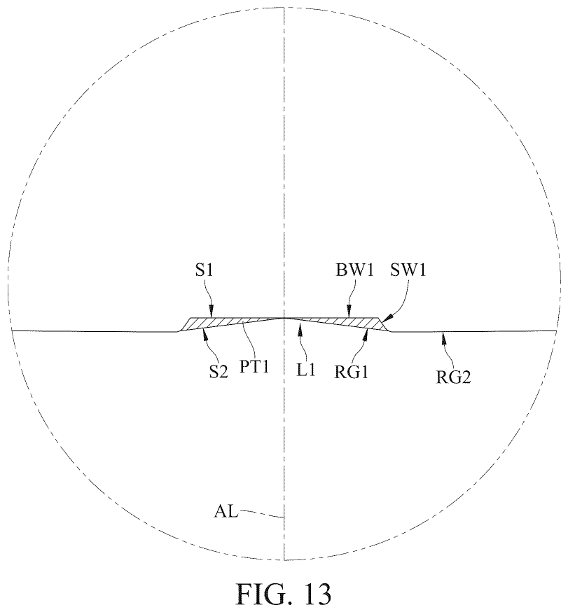

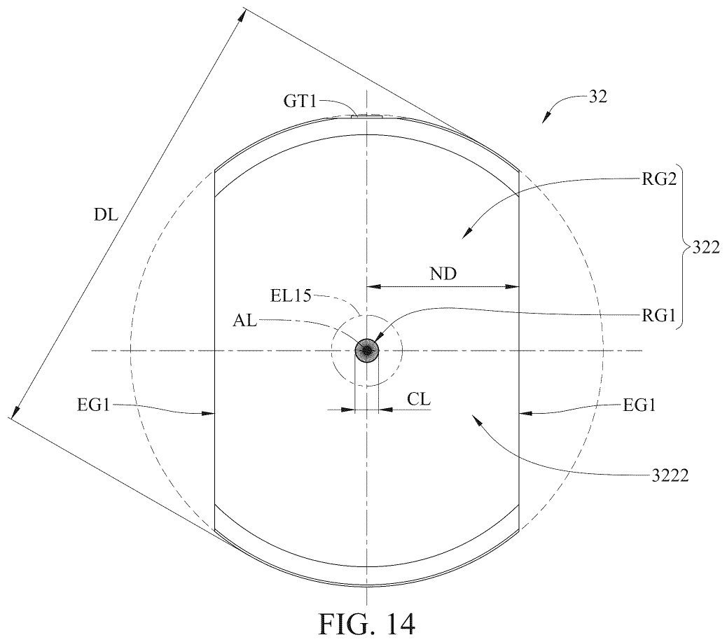

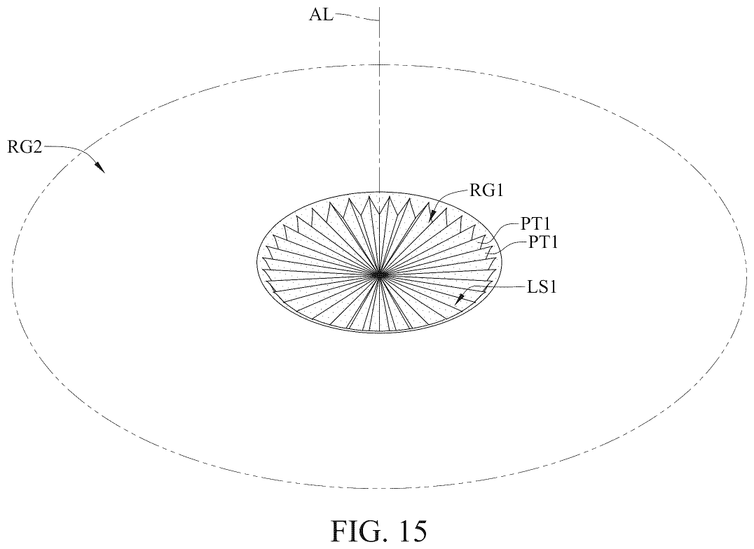

Please refer to FIG. 11 to FIG. 15. FIG. 11 is a cross-sectional view of a camera module according to the 3rd embodiment of the present disclosure, FIG. 12 is a cross-sectional view of a center-shielding lens element in the imaging lens of camera module in FIG. 11, FIG. 13 is an enlarged view of region EL13 in FIG. 12, FIG. 14 is a projection view of the center-shielding lens element of FIG. 12 in a direction perpendicular to a central axis, and FIG. 15 is an enlarged perspective view of region EL15 in FIG. 14.

A camera module 3 is provided in this embodiment. The camera module 3 includes an imaging lens 30 and an image sensor IS. The imaging lens 30 includes a barrel 31, a plurality of lens elements 32, 33 and 34, two reflective elements 35 and 36, a filter FT and an image surface IMG. The barrel 31 includes a minimum through hole (its reference numeral is omitted, but referable to the location indicated by the parameter BD shown in FIG. 11), and a central axis AL of the imaging lens 30 passes through the minimum through hole. The lens elements 32, 33 and 34 are disposed on the barrel 31 and sequentially arranged from an object side to an image side along an optical path, and the central axis AL passes through a center of each of the lens elements 32, 33 and 34. The filter FT is disposed between the lens elements 32, 33 and 34 and the image surface IMG in the direction of the optical path, and the image sensor IS is disposed on the image surface IMG.

The lens elements 32, 33 and 34 includes a center-shielding lens element 32 and a rearmost lens element 34. The center-shielding lens element 32 is a lens element closest to the object side among the lens elements 32, 33 and 34, and the rearmost lens element 34 is a lens element closest to the image side among the lens elements 32, 33 and 34. Moreover, the center-shielding lens element 32 is a positive lens element.

The lens elements 32, 33 and 34 include a first lens group LG1 and a second lens group LG2, the second lens group LG2 is disposed on an image side of the first lens group LG1, and each of the first lens group LG1 and the second lens group LG2 includes at least one lens element. In addition, the center-shielding lens element 32 is located in the first lens group LG1, and an axial distance between the first lens group LG1 and the second lens group LG2 is variable. In this embodiment, the second lens group LG2 is movable along the direction of the central axis AL.

The reflective element 35 is disposed between the first lens group LG1 and the second lens group LG2 in the direction of the optical path, and the reflective element 36 is disposed between the second lens group LG2 and the filter FT in the direction of the optical path. Moreover, the center-shielding lens element 32 is disposed on an object side of the reflective element 35. In this embodiment, the reflective element 35 includes a reflective surface 351, and the reflective element 36 includes a reflective surface 361.

The center-shielding lens element 32 includes a first optical surface 321 and a second optical surface 322. The central axis AL passes through the first optical surface 321, and the second optical surface 322 is disposed opposite to the first optical surface 321. Moreover, the first optical surface 321 is disposed on an object side of the center-shielding lens element 32, and the second optical surface 322 is disposed on an image side of the center-shielding lens element 32. In other words, the first optical surface 321 can be an object-side surface of the center-shielding lens element 32, and the second optical surface 322 can be an image-side surface of the center-shielding lens element 32. Imaging optical path sequentially passes through the first lens group LG1, the first optical surface 321 and the second optical surface 322 of the center-shielding lens element 32 included therein, then passes through the reflective element 35, the second lens group LG2, the reflective element 36 and the filter FT, and eventually forms an image on the image surface IMG.

The second optical surface 322 includes a center-shielding region RG1 and an optical transmission region RG2. The central axis AL passes through the center-shielding region RG1, and the center-shielding region RG1 includes a light-shielding layer L1. The optical transmission region RG2 is disposed adjacent to and surrounds the center-shielding region RG1.

An inner side S1 and an outer side S2 of the center-shielding region RG1 both have low reflectivity characteristics. Additionally, the outer side S2 of the center-shielding region RG1 is a surface of the light-shielding layer L1. In this embodiment, a reflectance of the inner side S1 of the center-shielding region RG1 is less than 30%, and a reflectance of the outer side S2 of the center-shielding region RG1 is also less than 30%.

As shown in FIG. 13 and FIG. 15, a matte structure LS1 is provided on the center-shielding region RG1, and at least a part of the light-shielding layer L1 is disposed on the matte structure LS1. The matte structure LS1 includes a plurality of protruding structures PT1 sequentially arranged based on the central axis AL. In this embodiment, the protruding structures PT1 are sequentially arranged in a circumferential direction relative to the central axis AL.

Additionally, as shown in FIG. 13, the center-shielding region RG1 includes a wall surface SW1 and a bottom surface BW1. The wall surface SW1 extends from a side of the optical transmission region RG2 closest to the central axis AL towards the first optical surface 321, and the bottom surface BW1 is connected to a side of the wall surface SW1 farthest from the optical transmission region RG2. Moreover, the light-shielding layer L1 is disposed on the wall surface SW1 and the bottom surface BW1.

As shown in FIG. 14, the center-shielding lens element 32 is a non-circular lens element and includes two trimmed edges EG1 disposed opposite to each other, and the trimmed edges EG1 are recessed towards the central axis AL. In addition, the center-shielding lens element 32 is a plastic lens element including a gate trace GT1 at its outer diameter, and the gate trace GT1 is located at a peripheral portion connecting the two trimmed edges EG1.

As shown in FIG. 12, the first optical surface 321 includes an object-side effective optical area 3211, and the optical transmission region RG2 of the second optical surface 322 includes an image-side effective optical area 3222. Furthermore, the image-side effective optical area 3222 is disposed adjacent to the center-shielding region RG1, and the optical path sequentially passes through the object-side effective optical area 3211 and the image-side effective optical area 3222. Moreover, in a direction parallel to the central axis AL, when a maximum distance from a position of the first optical surface 321 passed through by the central axis AL to an outer edge of the object-side effective optical area 3211 farthest from the central axis AL is SL1, and a maximum distance from a position of the second optical surface 322 passed through by the central axis AL to an outer edge of the image-side effective optical area 3222 farthest from the central axis AL is SL2, the following conditions are satisfied: SL1=0.52 mm; SL2=0.09 mm; and SL2/SL1=0.173.

As shown in FIG. 11, when the number of the lens elements 32, 33 and 34 is N, and the number of lens elements 33 and 34 disposed on the image side of the center-shielding lens element 32 is M, the following conditions are satisfied: N=8; M=7; and N×0.5 ≤M.

As shown in FIG. 14, on a projection plane perpendicular to the central axis AL, when a maximum shielding width of the center-shielding region RG1 is defined as CL, and a maximum outer diameter of the center-shielding lens element 32 is defined as DL, the following conditions are satisfied: CL=0.56 mm; DL=11.15 mm; and CL/DL=0.05.

As shown in FIG. 14, on a projection plane perpendicular to the central axis AL, when a minimum distance between the trimmed edge EG1 and the central axis AL is ND, and the maximum outer diameter of the center-shielding lens element 32 is defined as DL, the following conditions are satisfied: ND=3.59 mm; DL=11.15 mm; and ND×2/DL=0.644. Moreover, the center of the maximum outer diameter DL is aligned with the central axis AL.

As shown in FIG. 14, on a projection plane perpendicular to the central axis AL, when the maximum shielding width of the center-shielding region RG1 is defined as CL, and the minimum distance between the trimmed edge EG1 and the central axis AL is defined as ND, the following conditions are satisfied: CL=0.56 mm; ND=3.59 mm; and CL/(ND×2)=0.078.

As shown in FIG. 11, when a field of view of the imaging lens 30 is FOV, the following condition is satisfied: FOV=13.6 degrees. Moreover, the field of view of the imaging lens 30 corresponds to a maximum image height of the image sensor IS (its reference numeral is omitted, but corresponds to the intersection between the optical path and the image sensor IS as shown in FIG. 11).

As shown in FIG. 12, when a minimum distance between the outer edge of the image-side effective optical area 3222 farthest from the central axis AL and the first optical surface 321 is ET, and a central thickness of the center-shielding lens element 32 defined by the central axis AL passing through a center of the center-shielding lens element 32 is CT, the following conditions are satisfied: ET=0.37 mm; CT=0.97 mm; and ET/CT=0.381.

As shown in FIG. 11 and FIG. 14, on a projection plane perpendicular to the central axis AL, when the maximum shielding width of the center-shielding region RG1 is defined as CL, and a through hole diameter of the minimum through hole is defined as BD, the following conditions are satisfied: CL=0.56 mm; BD=10.14 mm; and CL/BD=0.06.

As shown in FIG. 11 and FIG. 14, on a projection plane perpendicular to the central axis AL, when a rearmost lens outer diameter of the rearmost lens element 34 is defined as DI, and the maximum outer diameter of the center-shielding lens element 32 is defined as DL, the following conditions are satisfied: DI=10.5 mm; DL=11.15 mm; and DI/DL=0.942.

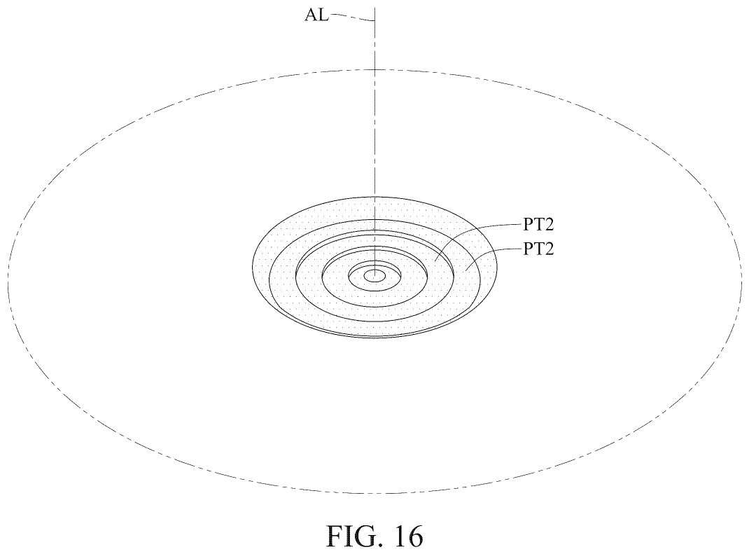

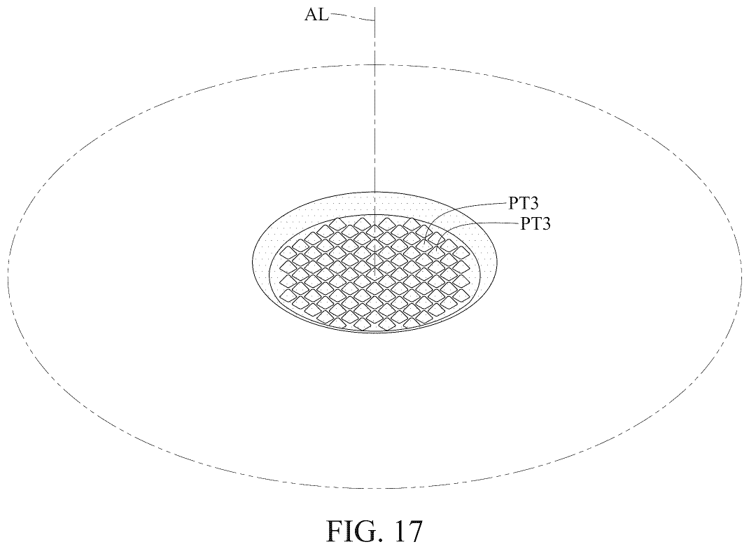

In this embodiment, as shown in FIG. 15, the protruding structures PT1 are sequentially arranged in a circumferential direction relative to the central axis AL, and the protruding structures PT1 radially extend from the central axis AL in a radial pattern, but the present disclosure is not limited thereto. For example, please refer to FIG. 16 and FIG. 17, which are enlarged perspective views of a matte structure according to other configurations of the present disclosure.

In the configuration of FIG. 16, a plurality of protruding structures PT2 are coaxial annular structures, and the protruding structure PT2 located at the outer periphery can have a greater protrusion height than the protruding structure PT2 located internally, but the present disclosure is not limited thereto.

In the configuration of FIG. 17, a plurality of protruding structures PT3 are sequentially arranged based on the central axis AL to form an array pattern, which can be symmetrical with respect to the central axis AL, and the shape of each of the protruding structures PT3 is conical, but the present disclosure is not limited thereto.

### 4th Embodiment

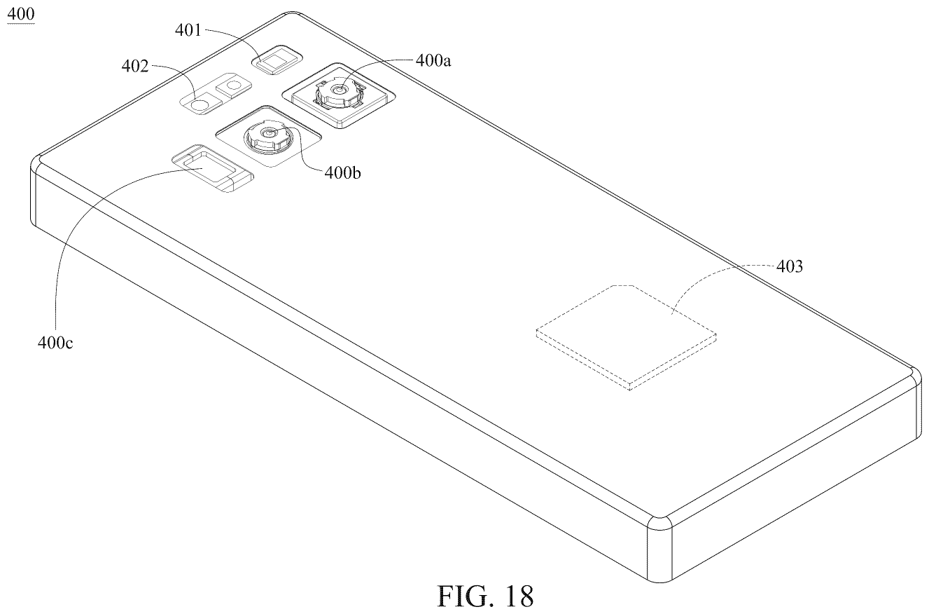

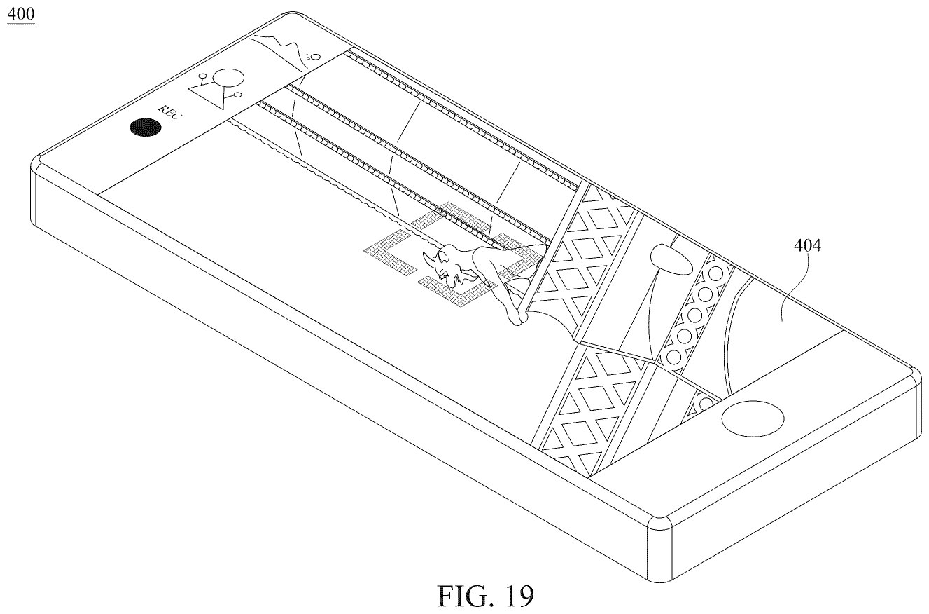

Please refer to FIG. 18 and FIG. 19. FIG. 18 is a perspective view of an electronic device according to the 4th embodiment of the present disclosure, and FIG. 19 is another perspective view of the electronic device in FIG. 18.

In this embodiment, the electronic device 400 is a smartphone including a plurality of camera modules 400a, 400b and 400c, a flash module 401, a focus assist module 402, an image signal processor 403, a display module (user interface) 404, and an image software processor (not shown).

These camera modules include an ultra-wide-angle camera module 400a, a high pixel camera module 400b and a telephoto camera module 400c. Moreover, the telephoto camera module 400c includes the imaging lens of the present disclosure and an image sensor (not shown), where the image sensor is disposed on the image surface of the imaging lens, but the present disclosure is not limited thereto. Each of the camera modules 400a and 400b can include the imaging lens of the present disclosure.

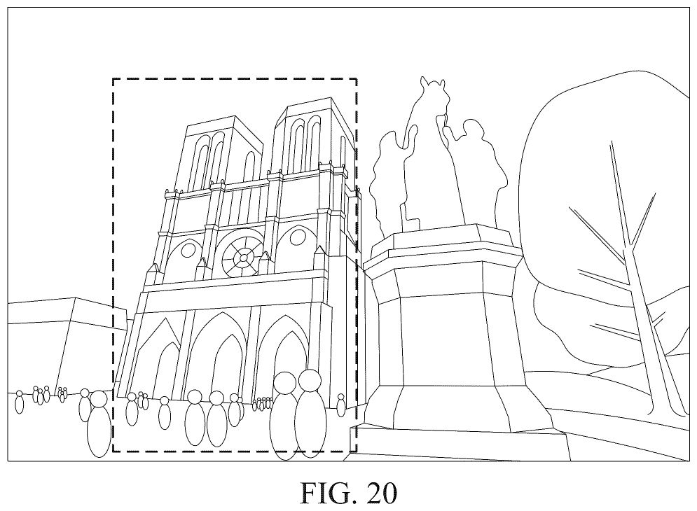

The image captured by the ultra-wide-angle camera module 400a enjoys a feature of multiple imaged objects. FIG. 20 is an image captured by the ultra-wide-angle camera module 400a.

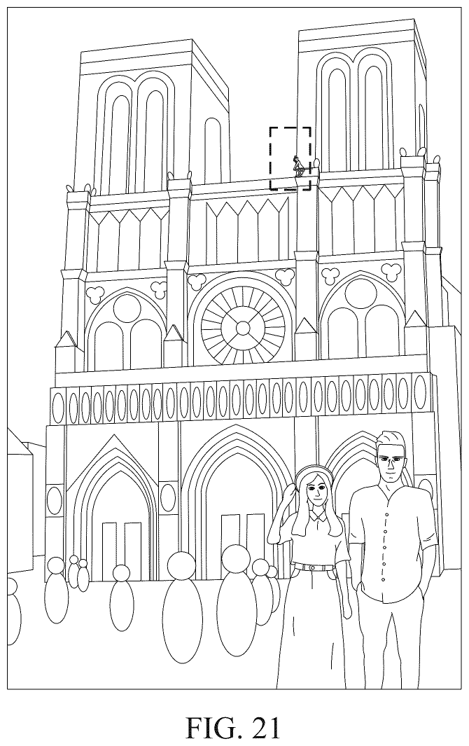

The image captured by the high pixel camera module 400b enjoys a feature of high resolution and less distortion, and the high pixel camera module 400b can capture part of the image in FIG. 20. FIG. 21 is an image captured by the high pixel camera module 400b.

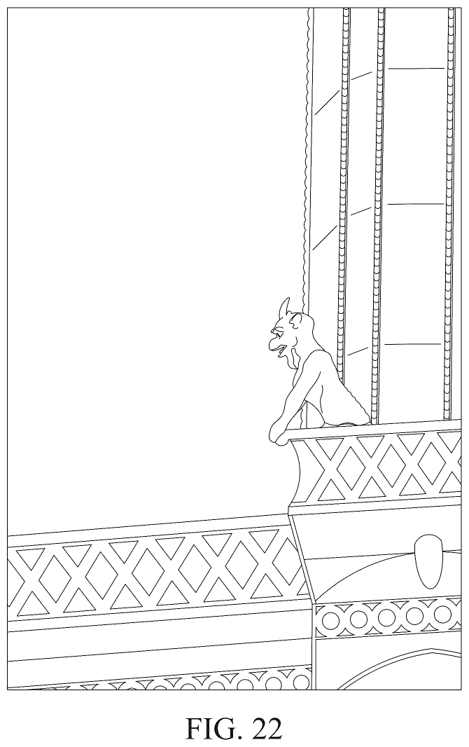

The image captured by the telephoto camera module 400c enjoys a feature of high optical magnification, and the telephoto camera module 400c can capture part of the image in FIG. 21. FIG. 22 is an image captured by the telephoto camera module 400c.

When a user captures images of an object, the light rays converge in the ultra-wide-angle camera module 400a, the high pixel camera module 400b or the telephoto camera module 400c to generate images, and the flash module 401 is activated for light supplement. The focus assist module 402 detects the object distance of the imaged object to achieve fast auto focusing. The image signal processor 403 is configured to optimize the captured image to improve imaging quality and provided zooming function. The light beam emitted from the focus assist module 402 can be either conventional infrared or laser. The display module 404 can include a touch screen, and the user is able to interact with the display module 404 to adjust the angle of view and switch between different camera modules, and the image software processor having multiple functions to capture images and complete image processing. Alternatively, the user may capture images via a physical button. The image processed by the image software processor can be displayed on the display module 404.

### 5th Embodiment

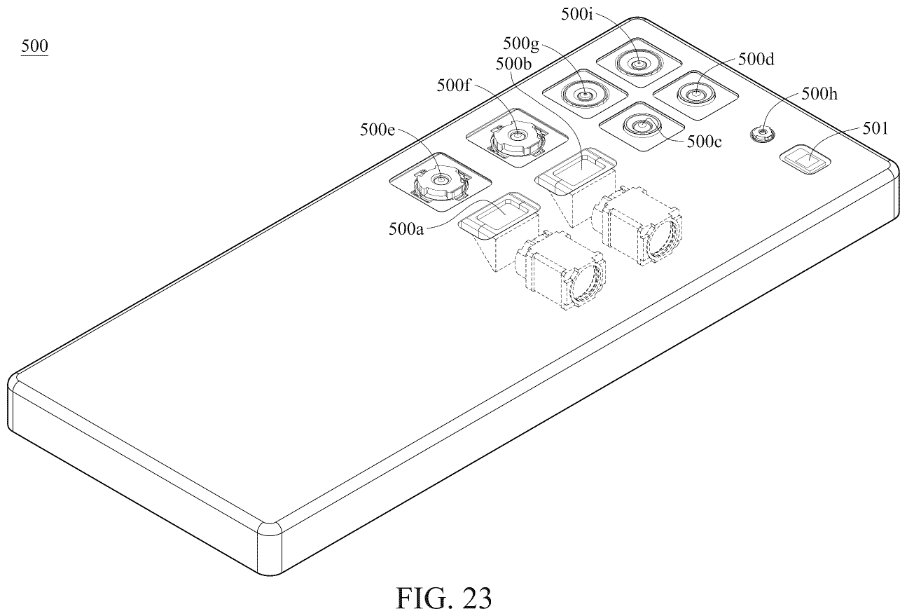

Please refer to FIG. 23, which is a perspective view of an electronic device according to the 5th embodiment of the present disclosure.

In this embodiment, the electronic device 500 is a smartphone including a camera module 500a, a camera module 500b, a camera module 500c, a camera module 500d, a camera module 500e, a camera module 500f, a camera module 500g, a camera module 500h, a camera module 500i, a flash module 501, an image signal processor, a display module, and an image software processor (not shown). The camera module 500a, the camera module 500b, the camera module 500c, the camera module 500d, the camera module 500e, the camera module 500f, the camera module 500g, the camera module 500h and the camera module 500i are disposed on the same side of the electronic device 500, while the display module is disposed on the opposite side of the electronic device 500. Moreover, the camera modules 500a, 500b and 500c each include the imaging lens of the present disclosure and an image sensor (not shown), and the image sensor is disposed on the image surface of the imaging lens.

The camera module 500a is a telephoto camera module with optical path folding function, the camera module 500b is a telephoto camera module with optical path folding function, the camera module 500c is a telephoto camera module, the camera module 500d is a telephoto camera module, the camera module 500e is a wide-angle camera module, the camera module 500f is a wide-angle camera module, the camera module 500g is an ultra-wide-angle camera module, the camera module 500h is a ToF (time of flight) camera module, and the camera module 500i is an ultra-wide-angle camera module. In this embodiment, the camera module 500i, the camera module 500a, the camera module 500b, the camera module 500c, the camera module 500d, the camera module 500e, the camera module 500f and the camera module 500g have different fields of view, such that the electronic device 500 can have various magnification ratios so as to meet the requirement of optical zoom functionality. In addition, the camera module 500a and camera module 500b are telephoto camera modules having a light-folding element configuration. In addition, the camera module 500h can determine depth information of the imaged object. In this embodiment, the electronic device 500 includes multiple camera modules 500a, 500b, 500c, 500d, 500e, 500f, 500g, 500h, and 500i, but the present disclosure is not limited to the number and arrangement of camera modules. When a user captures images of an object, the light rays converge in the camera module 500a, the camera module 500b, the camera module 500c, the camera module 500d, the camera module 500e, the camera module 500f, the camera module 500g, the camera module 500h or the camera module 500i to generate an image(s), and the flash module 501 is activated for light supplement. Further, the subsequent processes are performed in a manner similar to the abovementioned embodiments, so the details in this regard will not be provided again.

### 6th Embodiment

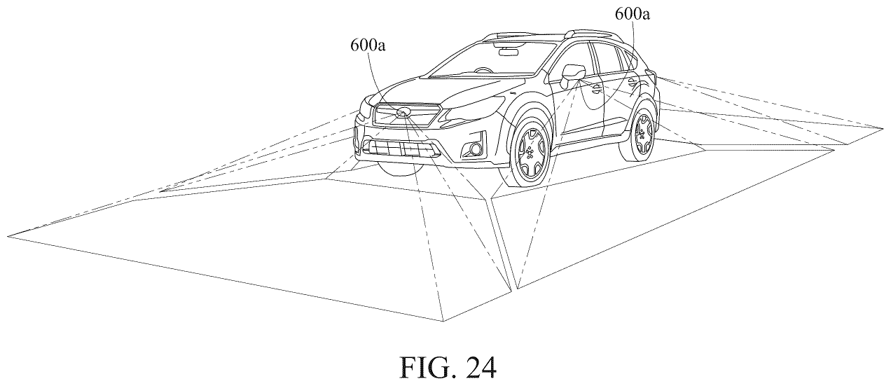

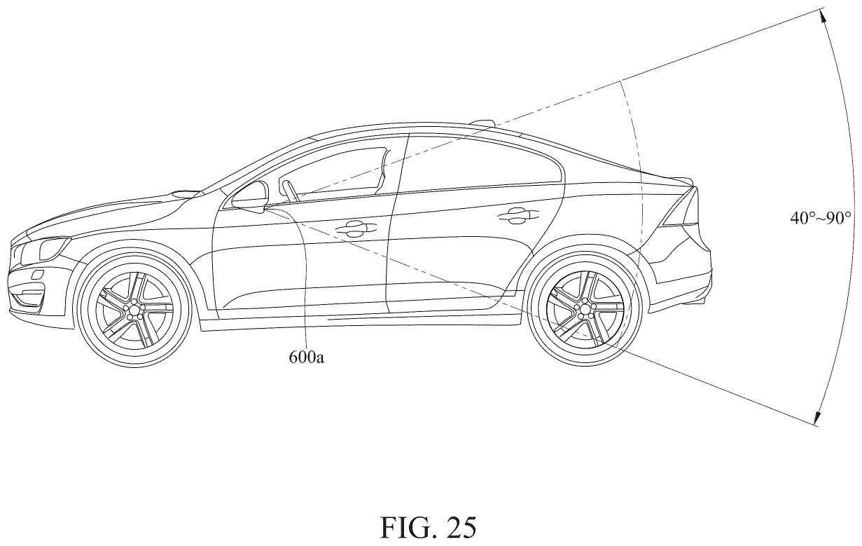

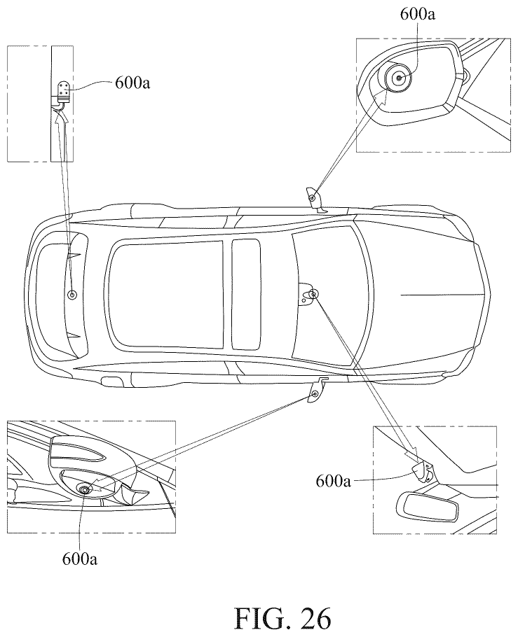

Please refer to FIG. 24 to FIG. 24. FIG. 24 is a perspective view of an electronic device according to the 6th embodiment of the present disclosure, FIG. 25 is a side view of the electronic device in FIG. 24, and FIG. 26 is a top view of the electronic device in FIG. 24.

In this embodiment, the electronic device 600 is an automobile. The electronic device 600 includes a plurality of automotive camera modules 600a, and the camera modules 600a each include the imaging lens of the present disclosure and an image sensor disposed on the image surface of the imaging lens. The camera modules 600a can serve as, for example, panoramic view car cameras, dashboard cameras and vehicle backup cameras.

As shown in FIG. 24, the camera modules 600a are, for example, disposed around the automobile to capture peripheral images of the automobile, which is favorable for obtaining external traffic information so as to achieve autopilot function. In addition, the image software processor may stitch the peripheral images into one panoramic view image for the driver's checking every corner surrounding the automobile, thereby favorable for parking and driving.

As shown in FIG. 25, the camera modules 600a are, for example, respectively disposed on the lower portion of the side mirrors. The field of view of the camera modules 600 a can be 40 degrees to 90 degrees for capturing images in regions on left and right Lanes.

As shown in FIG. 26, the camera modules 600a can also be, for example, respectively disposed on the lower portion of the side mirrors and inside the front and rear windshields for providing external information to the driver, and also providing more viewing angles so as to reduce blind spots, thereby improving driving safety.

The smartphones, panoramic view car cameras, dashboard cameras and vehicle backup cameras in the embodiments are only exemplary for showing the imaging lens and the camera module of the present disclosure installed in an electronic device, and the present disclosure is not limited thereto. The imaging lens and the camera module can be optionally applied to optical systems with a movable focus. Furthermore, the imaging lens and the camera module feature good capability in aberration corrections and high imaging quality, and can be applied to 3D (three-dimensional) image capturing applications, in products such as digital cameras, mobile devices, digital tablets, smart televisions, network surveillance devices, multi-camera devices, image recognition systems, unmanned aerial vehicles, motion sensing input devices, wearable devices and other electronic imaging devices.

The foregoing description, for the purpose of explanation, has been described with reference to specific embodiments. It is to be noted that the present disclosure shows different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An imaging lens comprising:
a plurality of lens elements sequentially arranged from an object side to an image side along an optical path, wherein a central axis of the imaging lens passes through a center of each of the plurality of lens elements, the plurality of lens elements comprise a center-shielding lens element, and the center-shielding lens element comprises:
a first optical surface, wherein the central axis passes through the first optical surface; and
a second optical surface, disposed opposite to the first optical surface; wherein the second optical surface comprises:
a center-shielding region, wherein the central axis passes through the center-shielding region, and the center-shielding region comprises a light-shielding layer; and
an optical transmission region disposed adjacent to and surrounding the center-shielding region;
wherein an inner side and an outer side of the center-shielding region both have low reflectivity characteristics.

2. The imaging lens of claim 1, wherein a number of the plurality of lens elements is N, a number of lens elements disposed on an image side of the center-shielding lens element among the plurality of lens elements is M, and the following condition is satisfied:
N×0.5≤M.

3. The imaging lens of claim 2, wherein the center-shielding lens element is a lens element closest to the object side among the plurality of lens elements.

4. The imaging lens of claim 1, further comprising a reflective element, wherein the center-shielding lens element is disposed on an object side of the reflective element.

5. The imaging lens of claim 4, wherein the reflective element comprises a plurality of reflective surfaces.

6. The imaging lens of claim 1, wherein the first optical surface is disposed on an object side of the center-shielding lens element, and the second optical surface is disposed on an image side of the center-shielding lens element.

7. The imaging lens of claim 6, wherein the first optical surface comprises an object-side effective optical area, the optical transmission region of the second optical surface comprises an image-side effective optical area, the image-side effective optical area is disposed adjacent to the center-shielding region, and the optical path sequentially passes through the object-side effective optical area and the image-side effective optical area; and
wherein in a direction parallel to the central axis, a maximum distance from a position of the first optical surface passed through by the central axis to an outer edge of the object-side effective optical area farthest from the central axis is SL1, a maximum distance from a position of the second optical surface passed through by the central axis to an outer edge of the image-side effective optical area farthest from the central axis is SL2, and the following condition is satisfied:
0.04≤SL2/SL1≤0.35.

8. The imaging lens of claim 1, wherein the light-shielding layer comprises a plurality of protruding edges disposed adjacent to the optical transmission region, the plurality of protruding edges are sequentially arranged around the central axis, and each of the plurality of protruding edges gradually tapers away from the central axis.

9. The imaging lens of claim 1, wherein a matte structure is provided on a surface of the center-shielding region, and the matte structure is rougher than a surface of the optical transmission region; and
wherein a surface roughness difference between the matte structure and the surface of the optical transmission region is ΔR, and the following condition is satisfied:
Ra 0.1 μm≤ΔR≤Ra7.0 μm, where Ra represents an arithmetic average roughness.

10. The imaging lens of claim 1, wherein a matte structure is provided on a surface of the center-shielding region, and the matte structure comprises a plurality of protruding structures sequentially arranged based on the central axis.

11. The imaging lens of claim 1, wherein the center-shielding region comprises:
a wall surface extending from a side of the optical transmission region closest to the central axis towards the first optical surface; and
a bottom surface connected to a side of the wall surface farthest from the optical transmission region;
wherein the light-shielding layer is disposed on the wall surface and the bottom surface.

12. The imaging lens of claim 1, wherein on a projection plane perpendicular to the central axis, a maximum shielding width of the center-shielding region is defined as CL, a maximum outer diameter of the center-shielding lens element is defined as DL, and the following condition is satisfied:
0.03≤CL/DL≤0.33.

13. The imaging lens of claim 1, wherein the center-shielding lens element is a non-circular lens element and comprises a trimmed edge, and the trimmed edge is recessed towards the central axis; and
wherein on a projection plane perpendicular to the central axis, a minimum distance between the trimmed edge and the central axis is defined as ND, a maximum outer diameter of the center-shielding lens element is defined as DL, a maximum shielding width of the center-shielding region is defined as CL, and the following conditions are satisfied:
0.49≤ND×2/DL≤0.9; and
0.04≤CL/(ND×2)≤0.45.

14. The imaging lens of claim 1, wherein a field of view of the imaging lens is FOV, and the following condition is satisfied:
6 degrees≤FOV≤65 degrees.

15. The imaging lens of claim 1, wherein the optical transmission region of the second optical surface comprises an image-side effective optical area, the image-side effective optical area is disposed adjacent to the center-shielding region, and the optical path passes through the image-side effective optical area; and
wherein a minimum distance between an outer edge of the image-side effective optical area farthest from the central axis and the first optical surface is ET, a central thickness of the center-shielding lens element defined by the central axis passing through a center of the center-shielding lens element is CT, and the following condition is satisfied:
0.13≤ET/CT≤0.95.

16. The imaging lens of claim 1, further comprising a barrel, wherein the center-shielding lens element is disposed on the barrel, the barrel comprises a minimum through hole, and the central axis passes through the minimum through hole; and
wherein on a projection plane perpendicular to the central axis, a maximum shielding width of the center-shielding region is defined as CL, a through hole diameter of the minimum through hole is defined as BD, and the following condition is satisfied:
0.03≤CL/BD≤0.52.

17. The imaging lens of claim 1, wherein the plurality of lens elements further comprise a rearmost lens element, and the rearmost lens element is a lens element closest to the image side among the plurality of lens elements; and
wherein on a projection plane perpendicular to the central axis, a rearmost lens outer diameter of the rearmost lens element is defined as DI, a maximum outer diameter of the center-shielding lens element is defined as DL, and the following condition is satisfied:
0.6≤DI/DL≤1.4.

18. The imaging lens of claim 1, wherein the second optical surface of the center-shielding lens element further comprises a peripheral shielding region disposed on a side of the optical transmission region farthest from the center-shielding region.

19. The imaging lens of claim 1, wherein the plurality of lens elements comprises a first lens group and a second lens group, the second lens group is disposed on an image side of the first lens group, and each of the first lens group and the second lens group comprises at least one lens element; and
wherein the center-shielding lens element is located in the first lens group, and an axial distance between the first lens group and the second lens group is variable.

20. An camera module comprising:
the imaging lens of claim 1; and
an image sensor disposed on an image surface of the imaging lens.

21. An electronic device comprising:
the camera module of claim 20.

22. An imaging lens comprising:
a plurality of lens elements sequentially arranged from an object side to an image side along an optical path, wherein a central axis of the imaging lens passes through a center of each of the plurality of lens elements, the plurality of lens elements comprise a center-shielding lens element, and the center-shielding lens element comprises:
a first optical surface, wherein the central axis passes through the first optical surface; and
a second optical surface, disposed opposite to the first optical surface; wherein the second optical surface comprises:
a center-shielding region, wherein the central axis passes through the center-shielding region, and the center-shielding region comprises a light-shielding layer; and
an optical transmission region disposed adjacent to and surrounding the center-shielding region;
wherein a matte structure is provided on the center-shielding region, and at least a part of the light-shielding layer is disposed on the matte structure.

23. The imaging lens of claim 22, wherein the matte structure is rougher than a surface of the optical transmission region; and
wherein a surface roughness difference between the matte structure and the surface of the optical transmission region is ΔR, and the following condition is satisfied:
Ra 0.1 μm≤ΔR≤Ra 7.0 μm, where Ra represents an arithmetic average roughness.

24. The imaging lens of claim 22, wherein the matte structure comprises a plurality of protruding structures sequentially arranged based on the central axis.

25. The imaging lens of claim 22, wherein a number of the plurality of lens elements is N, a number of lens elements disposed on an image side of the center-shielding lens element among the plurality of lens elements is M, and the following condition is satisfied:
N×0.5≤M.

26. The imaging lens of claim 22, wherein the first optical surface is disposed on an object side of the center-shielding lens element, and the second optical surface is disposed on an image side of the center-shielding lens element;
wherein the first optical surface comprises an object-side effective optical area, the optical transmission region of the second optical surface comprises an image-side effective optical area, the image-side effective optical area is disposed adjacent to the center-shielding region, and the optical path sequentially passes through the object-side effective optical area and the image-side effective optical area; and
wherein in a direction parallel to the central axis, a maximum distance from a position of the first optical surface passed through by the central axis to an outer edge of the object-side effective optical area farthest from the central axis is SL1, a maximum distance from a position of the second optical surface passed through by the central axis to an outer edge of the image-side effective optical area farthest from the central axis is SL2, and the following condition is satisfied:
0.04≤SL2/SL1≤0.35.

27. The imaging lens of claim 22, wherein on a projection plane perpendicular to the central axis, a maximum shielding width of the center-shielding region is defined as CL, a maximum outer diameter of the center-shielding lens element is defined as DL, and the following condition is satisfied:
0.03≤CL/DL≤0.33.

28. The imaging lens of claim 22, wherein the optical transmission region of the second optical surface comprises an image-side effective optical area, the image-side effective optical area is disposed adjacent to the center-shielding region, and the optical path passes through the image-side effective optical area; and
wherein a minimum distance between an outer edge of the image-side effective optical area farthest from the central axis and the first optical surface is ET, a central thickness of the center-shielding lens element defined by the central axis passing through a center of the center-shielding lens element is CT, and the following condition is satisfied:
0.13≤ET/CT≤0.95.

29. The imaging lens of claim 22, wherein the plurality of lens elements further comprises a rearmost lens element, and the rearmost lens element is a lens element closest to the image side among the plurality of lens elements; and
wherein on a projection plane perpendicular to the central axis, a rearmost lens outer diameter of the rearmost lens element is defined as DI, a maximum outer diameter of the center-shielding lens element is defined as DL, and the following condition is satisfied:
0.6≤DI/DL≤1.4.
